(19) United States
(12) Patent Application Publication
(10) Pub. No.: US 2002/0025202 A1
(43) Pub. Date: Feb. 28, 2002

(54) Process unit with cleaner and image forming apparatus comprising the same

(75) Inventors: Satoshi Itaya, Mishima-shi (JP); Tomoyuki Kato, Mishima-shi (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: Toshiba Tec Kabushiki Kaisha, Tokyo (JP)

(21) Appl. No.: 09/939,146

(22) Filed: Aug. 24, 2001

(30) Foreign Application Priority Data
Aug. 29, 2000 (JP) 2000-259355

(51) Int. Cl. G03G 21/00

(52) U.S. Cl. 399/350; 399/358

(57) ABSTRACT

A process unit with a cleaner, includes a photosensitive drum and a cleaner which removes magnetic toner sticking on the outer circumferential surface of the drum. The cleaner has a blade for scraping the toner on the outer circumferential surface of the drum, a paddle, having radially projecting arms, for removing the scraped toner by the blade, from a toner scraping position, a magnet, provided on the arm in a side opposite to a paddle rotating direction, for attracting the scraped toner on the arm in another side of the arm in the paddle rotating direction, by a magnetic force, a scraper, provided to contact the arm, for scraping off the toner attracted on the arm, and a scraped toner receiver for receiving the scraped toner scraped off from the arm.

### CROSS REFERENCE TO RELATED APPLICATION

This application is based upon and claims the benefit of the priority from the prior Japanese Patent Application No. 2000-259355, filed on Aug. 29, 2000, the entire contents of which are incorporated herein by reference.

### BACKGROUND OF THE INVENTION

1. Field of the Invention

The present invention relates to a process unit with a cleaner and an image forming apparatus comprising the same.

2. Description of the Related Art

An electrophotographic image forming apparatus which comprises a conveyor device for conveying recording papers and an image forming mechanism for forming a desired image on a recording paper conveyed by the conveyor is well-known. The image forming mechanism includes a rotatable photosensitive drum, a charger for charging an outer circumferential surface of the photosensitive drum, an exposure device for forming a desired electrostatic latent image on the charged outer circumferential surface of the photosensitive drum, a developing device for developing the electrostatic latent image on the outer circumferential surface of the photosensitive drum with toner having magnetism to form a toner image, a transfer device for transferring the toner image formed on the outer circumferential surface of the photosensitive drum to a recording paper being conveyed by the conveyor, and a cleaner for removing toner remaining on the outer circumferential surface of the photosensitive drum after transferring the toner image from the outer circumferential surface of the photosensitive drum to the recording paper being conveyed.

In recent years, electrophotographic image forming apparatuses have been sold, in which the conveyor and various devices included in the image forming mechanism are arranged for reducing an area on a floor required to place each of the apparatuses thereon. In this kind of image forming apparatus, the conveyor is arranged to convey recording papers upward from the vicinity of the floor. And, this kind of apparatus is called as a vertical recording-paper conveyance type image forming apparatus. In the vertical recording-paper conveyance type image forming apparatus, the photosensitive drum and the transfer device of the image forming mechanism are provided in both sides of a convey path of recording papers extending from a lower end of the conveyor to an upper end thereof. Further, in the side of the convey path where the photosensitive drum is provided, the cleaner, the charger, the exposure device, and the developing device are provided in this order around the outer circumferential surface of the photosensitive drum from an upper side of the drum to a lower side thereof. The rotation direction of the photosensitive drum is equal to the convey direction of the recording paper on the convey path to which the photosensitive drum faces.

In the vertical conveyance type image forming apparatus, therefore, the cleaner is provided in the upper side of the outer circumferential surface of the photosensitive drum, to be adjacent to the outer circumferential surface. The cleaner includes a remaining toner scraping blade pressed against an upper part of the outer circumferential surface of the photosensitive drum. Therefore, remaining toner scraped off by the blade from the upper part of the outer circumferential surface of the rotating photosensitive drum stays at the upper part of the outer circumferential surface of the rotating photosensitive drum by the action of gravity.

The cleaner in the conventional vertical conveyance type image forming apparatus has a paddle which rotates near the tip end of the scraping blade, and a storage container for scraped and remaining toner. The paddle cyclically fed scraped and remaining toner which stays at the upper part of the outer circumferential surface of the rotating photosensitive drum to a portion distant from the upper part of the outer circumferential surface of the photosensitive drum in the storage container.

However, gaps are maintained between tip ends of the paddle and a surface of the scraping blade and between the tip ends of the paddle and the upper part of the outer circumferential surface of the photosensitive drum, in order to prevent them from colliding with each other. In addition, a part of scraped and remaining toner being fed into the distant portion of the toner storage container from the upper part of the outer circumferential surface of the photosensitive drum by the paddle falls down on the upper part of the outer circumferential surface of the photosensitive drum from the paddle. Therefore, in the cleaner of the conventional vertical conveyance type image forming apparatus, scraped and remaining toner easily accumulates on the upper part of the outer circumferential surface of the photosensitive drum, so that scraped and remaining toner leaks from the cleaner in some cases. Further, paper particles sticking to the outer circumferential surface of the photosensitive drum from recording papers, products generated by corona discharge in a case of using corona discharge in the charger or transfer device and sticking to the outer circumferential surface of the photosensitive drum, and any other objects sticking to the outer circumferential surface of the photosensitive drum, together with scraped and remaining toner, are also scraped off from the outer circumferential surface of the photosensitive drum by the blade and stay on the upper part of the outer circumferential surface of the photosensitive drum.

The present invention has been derived from the above described situation, and an object of the present invention is to provide a process unit with a cleaner, which scrapes off remaining toner from the upper part of the outer circumferential surface of the photosensitive drum and includes a paddle feeding cyclically the scraped and remaining toner to a position distant from the upper part of the photosensitive drum, the process unit with a cleaner being capable of feeding more steadily the scraped and remaining toner from the upper part of the outer circumferential surface of the photosensitive drum to the distant position, and also being capable of reducing more the amount of the scraped and remaining toner which accumulates on the upper part of the outer circumferential surface of the photosensitive drum.

Also, the object is to provide an image forming apparatus comprising the process unit with a cleaner as described above.

### BRIEF SUMMARY OF THE INVENTION

To achieve the above-described object of the present invention, a process unit with a cleaner, according to the present invention, comprises:

a photosensitive drum which is rotatable and has an outer circumferential surface on which magnetic toner is to be sticked; and

a cleaner which removes magnetic toner sticking on the outer circumferential surface of the photosensitive drum,

the cleaner including

a blade which scrapes the magnetic toner sticking on the outer circumferential surface of the photosensitive drum from the outer circumferential surface,

a paddle which has a rotation center and at least one arm projecting outward in a radial direction from the rotation center, rotates in a predetermined direction at a position near a toner scraping position by the blade on the outer circumferential surface of the photosensitive drum, and moves cyclically the scraped magnetic toner scraped from the outer circumferential surface of the photosensitive drum by the blade, from the toner scraping position,

a magnet which is provided on the arm in a side opposite to a direction in which the paddle rotates, and attracts the scraped magnetic toner on the arm of the paddle in another side of the arm located in the direction in which the paddle rotates, by a magnetic force,

a scraper which is provided in a side of the paddle opposite to the outer circumferential surface of the photosensitive drum, contacts the arm of the paddle in the side located in the direction in which the paddle rotates during rotation of the paddle, and scrapes off the magnetic toner attracted on the arm of the paddle in the side located in the direction in which the paddle rotates, by the magnetic force, and

a scraped-magnetic toner receiver which receives the scraped magnetic toner scraped off from the arm of the paddle.

To achieve the above-described object of the present invention, an image forming apparatus according to the present invention comprises:

a conveyor which conveys a recording paper upward;

a photosensitive drum which rotates in a predetermined direction;

a charger which charges an outer circumferential surface of the photosensitive drum;

an exposing device which forms a desired electrostatic latent image on the charged outer circumferential surface of the photosensitive drum;

a developing device which develops the electrostatic latent image by magnetic toner and forms a toner image;

a transfer device which transfers the toner image formed on the outer circumferential surface of the photosensitive drum, to the recording paper being conveyed by the conveyor; and

a cleaner which removes the magnetic toner sticking on the outer circumferential surface of the photosensitive drum, after transferring the toner image from the outer circumferential surface of the photosensitive drum to the recording paper being conveyed by the conveyor,

the cleaner being provided adjacent to an upper part of the outer circumferential surface of the photosensitive drum, and

the cleaner including

a blade which scrapes the magnetic toner sticking on the outer circumferential surface of the photosensitive drum from the outer circumferential surface,

a paddle which has a rotation center and at least one arm projecting outward in a radial direction from the rotation center, rotates in a predetermined direction at a position near a toner scraping position by the blade on the outer circumferential surface of the photosensitive drum, and moves cyclically the scraped magnetic toner scraped from the outer circumferential surface of the photosensitive drum by the blade, from the toner scraping position,

a magnet which is provided on the arm in a side opposite to a direction in which the paddle rotates, and attracts the scraped magnetic toner on the arm of the paddle in another side of the arm located in the direction in which the paddle rotates, by a magnetic force,

a scraper which is provided in a side of the paddle opposite to the outer circumferential surface of the photosensitive drum, contacts the arm of the paddle in the side located in the direction in which the paddle rotates during rotation of the paddle, and scrapes off the magnetic toner attracted on the arm of the paddle in the side located in the direction in which the paddle rotates, by the magnetic force, and

a scraped-magnetic toner receiver which receives the scraped magnetic toner scraped off from the arm of the paddle.

### BRIEF DESCRIPTION OF THE SEVERAL VIEWS OF THE DRAWING

The accompanying drawings, which are incorporated in and constitute a part of the specification, illustrate an embodiment, and together with the general description given above and the detailed description of the embodiment given below, serve to explain the principles of the invention.

FIG. 1 is a schematical vertical cross-sectional view of an image forming apparatus, the image forming apparatus comprising a process unit with a cleaner, according to an embodiment of the present invention; and

FIG. 2 is an enlarged longitudinal cross-sectional view of a main part of the cleaner shown in FIG. 1.

### DETAILED DESCRIPTION OF THE INVENTION

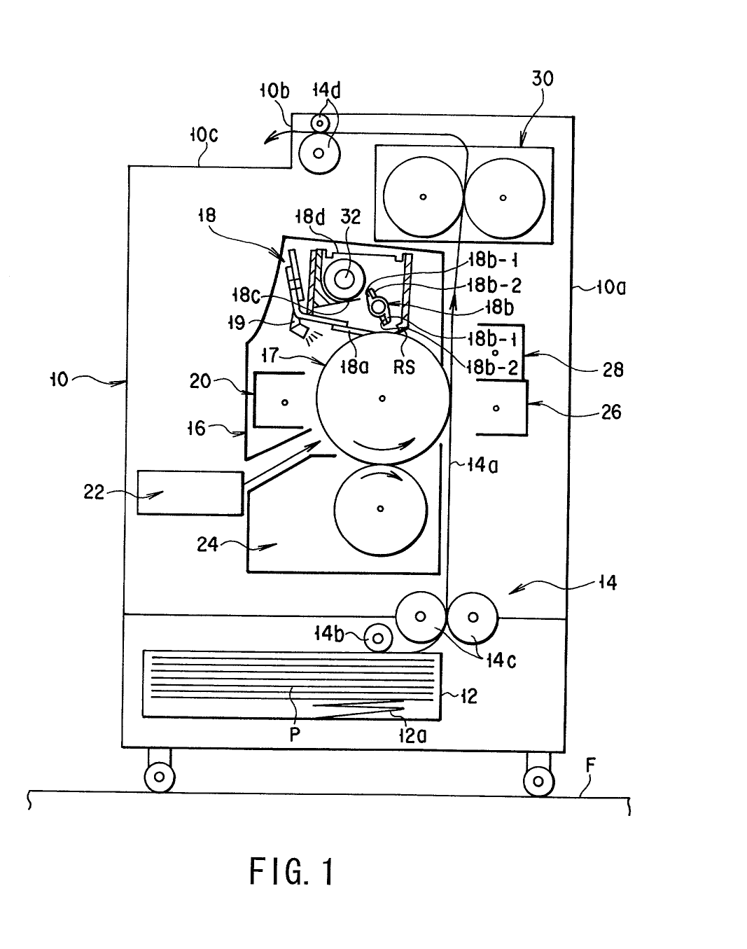

FIG. 1 shows a schematical vertical cross-sectional view of an image forming apparatus 10, and the image forming apparatus 10 comprises a process unit with a cleaner, according to an embodiment of the present invention. An outer housing 10a of the image forming apparatus 10 is located on a floor F of a building. In the outer housing 10a, a paper feed cassette 12 is detachably arranged at a predetermined position near the floor F. The paper feed cassette 12 contains a plurality of recording papers P in a stacked condition, the recording papers P having the same predetermined size and shape as to each other, and urging means 12a for urging one end portion of the plurality of stacked recording papers P upward is provided in the cassette 12.

In the outer housing 10a, a recording paper conveyance path 14a extends upward from one end portion of the cassette 12, and an upper end of the recording paper conveyance path 14a reaches at an opening 10b formed in an upper wall of the outer housing 10a. A pick-up roller 14b contacts the one end portion of an upper surface of an upper most recording paper in the plurality of stacked recording papers P urged upward in the cassette 12 as described above.

At a lower end portion of the recording paper conveyance path 14a, a pair of recording paper feeding rollers 14c are arranged in both sides of the lower end portion. At the upper end portion of the recording paper conveyance path 14a, a pair of recording paper discharging rollers 14d are arranged in both sides of the upper end portion. Along an intermediate portion of the recording paper conveyance path 14a between the lower end portion and the upper end portion, a plurality of pairs of recording paper conveying rollers not shown are arranged in both sides of the intermediate portion.

When the pick-up roller 14b makes one rotation, the upper most recording paper in the plurality of stacked recording papers P in the cassette 12a is picked up by the pick-up roller 14b toward the paired recording paper feeding rollers 14c at the lower end portion of the recording paper conveyance path 14a. The paired recording paper feeding rollers 14c feed the recording paper into the intermediate portion of the conveyance path 14a. The recording paper in the intermediate portion of the conveyance path 14a is conveyed by the plurality of pairs of recording paper conveying rollers not shown toward the paired recording paper discharging rollers 14d. The paired recording paper discharging rollers 14d discharge the recording paper from the upper end portion of the recording paper conveyance path 14a onto a discharged paper tray 10c formed adjacent to the opening 10b on the upper wall of the outer housing 10a, through the opening 10b.

As apparent from the above description, in this embodiment, the recording paper conveyance path 14a, the paired recording paper feeding rollers 14c at the lower end portion of the recording paper conveyance path 14a, the plurality of pairs of recording paper conveying rollers along the intermediate end portion of the recording paper conveyance path 14a, and the paired recording paper discharging rollers 14d at the upper end portion of the recording paper conveyance path 14a configure a conveyor 14.

Further in the outer housing 10a, an image forming mechanism 16 is contained and the image forming mechanism 16 is used for forming a desired image by an electrophotographic process on the recording paper conveyed upward along the recording paper conveyance path 14a by the conveyor 14. The image forming mechanism 16 is arranged along the intermediate end portion of the recording paper conveyance path 14a.

The image forming mechanism 16 in this embodiment comprises a photosensitive drum 17 which is arranged adjacent to the recording paper conveyance path 14a in one side of the recording paper conveyance path 14a. The photosensitive drum 17 is rotated in a predetermined direction by which a conveying direction of the recording paper in the conveyance path 14a at a position where the photosensitive drum 17 contacts the conveyed recording paper is made equal to a moving direction of the outer circumferential surface of the photosensitive drum 17 at the position where the photosensitive drum 17 contacts the conveyed recording paper.

The image forming mechanism 16 further comprises a cleaner 18, a discharger 19, a charger 20, an exposing device 22, and a developing device 24 those of which are arranged around the outer circumferential surface of the photosensitive drum 17 from the upper portion of the outer circumferential surface to the lower portion thereof in the one side of the conveyance path 14a. The arrangement order of the cleaner 18, the discharger 19, the charger 20, the exposing device 22, and the developing device 24 around the outer circumferential surface of the photosensitive drum 17 is in accordance with the above described moving direction of the outer circumferential surface of the photosensitive drum 17.

The image forming mechanism 16 further comprises a transfer device 26 and a separator 28 both of which are arranged in another side of the conveyance path 14a. The transfer device 26 is positioned near to the outer circumferential surface of the photosensitive drum 17, and the separator 28 is positioned in a down stream side of the transfer device 26 in the conveying direction of the recording paper in the conveyance path 14a.

In the outer housing 10a, a fixing device 30 is further arranged along the intermediate portion of the conveyance path 14a in the down stream side of the image forming mechanism 16 in the conveying direction of the recording paper in the conveyance path 14a.

In order to form a desired image on the recording paper in the image forming apparatus 10 according to the embodiment configured as described above, a recording paper is picked up from the cassete 12 to the conveyance path 14a by the pick-up roller 14b, and the photosensitive drum 17 is made one rotation in the predetermined direction at a predetermined speed. During this rotation, the charger 20 charges electrically and uniformly the outer circumferential surface of the photosensitive drum 17. The exposing device 22 forms a desired latent image corresponding to the desired image on the uniformly charged outer circumferential surface of the photosensitive drum 17. The developing device 24 develops the latent image on the outer circumferential surface of the photosensitive drum 17 with magnetic toner and forms a toner image. The transfer device 26 transfers the toner image on the outer circumferential surface of the photosensitive drum 17 onto the recording paper conveyed in the conveyance path 14a to the photosensitive drum 17. The separator 28 separates the recording paper on which the toner image has been transferred, from the outer circumferential surface of the photosensitive drum 17. The fixing device 30 fixes the transferred toner image on the recording paper when the recording paper reaches at the fixing device 30 after the recording paper has been separated from the outer circumferential surface of the photosensitive drum 17. The recording paper on which the toner image corresponding to the desired image has been fixed is discharged onto the discharged recording paper tray 10c on the upper wall of the outer housing 10a by the paired recording paper discharging rollers 14d at the upper end portion of the conveyor 14.

Residual toner on the outer circumferential surface of the photosensitive drum 17 after the toner image has been transferred from the outer circumferential surface to the recording paper by the transfer device 26, is removed from the outer circumferential surface of the photosensitive drum 17 by the cleaner 18. Next, the discharger 19 discharges residual electric charge from the outer circumferential surface of the photosensitive drum 17, and the outer circumferential surface of the photosensitive drum 17 is ready for a next image formation.

In the vertical conveyance type image forming apparatus 10 configured as described above, the cleaner 10 is located near the upper portion of the outer circumferential surface of the photosensitive drum 17.

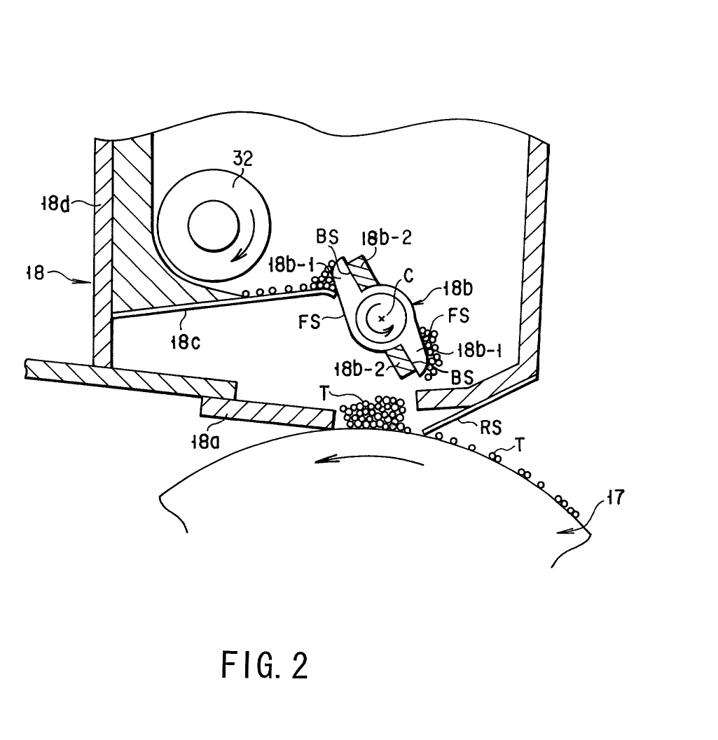

In the following, a configuration of the cleaner 18 will be described in detail with reference to FIG. 2, in addition to FIG. 1.

The cleaner 18 includes a blade 18a which has a free end contacting the upper portion of the outer circumferential surface of the photosensitive drum 17, a paddle 18b which is located near and above the free end of the blade 18a, a scraper 18c which is provided in a position near the paddle 18b but opposite to the outer circumferential surface of the photosensitive drum 17, and a container (or a housing) 18d which contains the blade 18a, the paddle 18b, and the scraper 18c.

The container (or a housing) 18d has an opening which faces the upper portion of the outer circumferential surface of the photosensitive drum 17.

The free end of the blade 18a is located in the opening of the container 18d and directs in a direction opposite to the above described predetermined rotating direction of the photosensitive drum 17. The blade 18a has a base end portion which is fixed to the container 18d. During the photosensitive drum 17 rotates in the above described predetermined direction, the free end of the blade 18a scrapes the magnetic toner (the residual toner) sticking on the outer circumferential surface of the photosensitive drum 17 after the toner image transfer has been performed by the transfer device 26. The scraped residual toner T stays on the upper portion of the outer circumferential surface of the photosensitive drum 17 by gravity, even though the photosensitive drum 17 rotates.

A base end portion of a recovery sheet RS is fixed to a front edge of the opening of the container 18d, the front edge being located in a direction opposite to the above described predetermined rotating direction of the photosensitive drum 17. The recovery sheet RS extends from the front edge in the above described predetermined rotating direction of the photosensitive drum 17, and the extending end of the recovery sheet RS contacts the upper portion of the outer circumferential surface of the photosensitive drum 17. The recovery sheet RS prevents the scraped residual toner T stayed on the upper portion of the outer circumferential surface of the photosensitive drum 17 even though the photosensitive drum 17 rotates, from falling out from the upper portion of the outer circumferential surface of the photosensitive drum 17 in a front edge side of the opening of the container 18d.

The paddle 18b has a rotation center C and at least one arm 18b-1 projecting outward from the rotation center C in a radial direction of the rotation center C. The paddle 18b is rotated at a predetermined speed in a predetermined direction by a rotation force applied to the paddle 18b from a rotation power source not shown during the photosensitive drum 17 rotates, and the rotation direction of the paddle 18b is the same as that of the photosensitive drum 17. In this embodiment, the paddle 18b has two arms 18b-1, but the paddle 18b may have any number of arms.

The paddle 18b is located near a toner scraping position on the upper portion of the outer circumferential surface of the photosensitive drum 17, at the toner scraping position the free end of the blade 18a contacting the upper portion of the outer circumferential surface of the photosensitive drum 17. The paddle 18b rotates in the predetermined direction, and moves cyclically the scraped residual toner T stayed on the upper portion of the outer circumferential surface of the photosensitive drum 17, upward away from the upper portion by the two arms 18b-1.

A magnet 18b-2 is fixed on a side of each of the two arms 18b-1, that side being located on each of the two arms 18b-1 in a direction opposite to the rotation direction of the paddle 18b. One magnetic pole of the magnet 18b-2 which attracts the magnetic toner is orientated in the rotation direction of the paddle 18b, and another magnetic pole of the magnet 18b-2 which distracts the magnetic toner is orientated in the direction opposite to the rotation direction of the paddle 18b. The radially outward end of the magnet 18b-2 on the arm 18b-1 is positioned radially inner than the radially outward end of the arm 18b-1. Further, a paddle rotation direction side FS of each of the two arms 18b-1 of the paddle 18b is so set that it is inclined backward while it is apart outward from the rotation center C of the paddle 18b.

During the rotation of the paddle 18b, the two arms 18b-1 of the paddle 18b cyclically approach the scraped residual toner T stayed on the upper portion of the outer circumferential surface of the photosensitive drum 17, and attract the scraped residual toner T on the paddle rotation direction sides FS by the magnetic force of the magnets 18b-2. The scraped residual toner T attracted on the paddle rotation direction sides FS of the two arms 18b-1 of the paddle 18b by the magnetic force of the magnets 18b-2 do not fall from the paddle rotation direction sides FS while each of the two arms 18b-1 moves upward from the toner scraping position on the upper portion of the outer circumferential surface of the photosensitive drum 17. In the paddle 18b, at least the two arms 18b-1 are preferably formed of a material which has an electric-conductivity, such as a copper alloy, an aluminum alloy, an electric conductive resin, etc. If at least the two arms 18b-1 of the paddle 18b are formed of the electric conductive material as described above, the two arms 18b-1 are efficiently magnetized by the magnets 18b-2, so that each of the two arms 18b-1 can attract almost all of the scraped residual toner T stayed on the upper portion of the outer circumferential surface of the photosensitive drum 17 at every time each arm 18b-1 approaches the scraped residual toner T and no scraped residual toner T is stayed on the upper portion of the outer circumferential surface.

The scraper 18c is formed of a material having elasticity and is provided in the container 18d in a side of the paddle 18b opposite to the upper portion of the outer circumferential surface of the photosensitive drum 17. The scraper 18c has a tip end portion projecting into rotation locus of the two arms 18b-1 of the paddle 18b and a base end portion fixed to the container 18d. The tip end portion is located above at least an intermediate portion between the tip end portion and the base end portion, so that the scraper 18c configures a scraped residual toner receiver.

During the paddle 18b rotates as described above, the paddle rotation direction side FS of each of the two arms 18b-1 contacts the tip end portion of the scraper 18c at every time each of the two arms 18b-1 approaches in the side of the paddle 18b opposite to the upper portion of the outer circumferential surface of the photosensitive drum 17. Each of the two arms 18b-1 moves with pushing the tip end portion of the scraper 18c by the paddle rotation direction side FS, so that the tip end portion of the scraper 18c scrapes the scraped residual toner T attracted by magnetic force on the paddle rotation direction side FS of each of the two arms 18b-1, from the paddle rotation direction side FS.

Since the radially outward end of the magnet 18b-2 on the arm 18b-1 is positioned radially inner than the radially outward end of the arm 18b-1, the tip end portion of the scraper 18c does not collide with the radially outward end of the magnet 18b-2 on the arm 18b-1 just after the radially outward end of the arm 18b-1 has passed the tip end portion of the scraper 18c. Therefor, the radially outward end of the magnet 18b-2 on the arm 18b-1 does not be damaged by the tip end portion of the scraper 18c. Since it is proper that the tip end portion of the scraper 18c does not contact a surface of the magnet 18b-2 opposing to the rotation direction of the paddle 18b, the magnet 18b-2 being fixed on the rotation direction oppositing side BS of each of the two arms 18b-1, at every time the radially outward end of the arm 18b-1 has passed the tip end portion of the scraper 18c, the opposing surface of the magnet 18b-2 does not be abraded and damaged by the tip end portion of the scraper 18c.

The scraped residual toner T scraped from the paddle rotation direction side FS of each of the two arms 18b-1 by the tip end portion of the scraper 18c is received by the scraped residual toner receiver of the intermediate portion of the scraper 18c.

An auger conveyor 32 is arranged above and near the upper surface of the intermediate portion of the scraper 18c in the container 18d. The auger conveyor 32 discharges the scraped residual toner T received by the upper surface of the intermediate portion of the scraper 18c, to a residual toner reservoir located outside of the container 18d and not shown.

The scraped residual toner receiver may be formed independently of the scraper 18c.

In the cleaner 18 of the image forming apparatus 10 configured as described above, the scraped residual toner T scraped from the upper portion of the outer circumferential surface of the photosensitive drum 17 by the blade 18a and stayed on the upper portion of the outer circumferential surface, is attracted on the paddle rotation direction side FS of each of the two arms 18b-1 of the paddle 18b by the magnet 18b-2 fixed on each of the two arms 18b-1 during the paddle 18b rotates. The scraped residual toner T attracted on the paddle rotation direction side FS of each of the two arms 18b-1 of the paddle 18b is moved upward and away from the upper portion of the outer circumferential surface with the rotation of the paddle 18b. Then, the tip end portion of the scraper 18c contacts the paddle rotation direction side FS of each of the two arms 18b-1 of the paddle 18b and scrapes the scraped residual toner T attracted on the paddle rotation direction side FS of each of the two arms 18b-1 of the paddle 18b. The scraped residual toner T is received by the scraped residual toner receiver (the intermediate portion of the scraper 18c), and finally the scraped residual toner T on the scraped residual toner receiver is discharged by the auger conveyor 32 to the residual toner reservoir located outside of the container 18d and not shown.

As apparent from the above description, the scraped residual toner T can be surely moved from the upper portion of the outer circumferential surface of the photosensitive drum 17 to a position located away from the upper portion of the outer circumferential surface, and an amount of the scraped residual toner T stayed on the upper portion of the outer circumferential surface can be reduced greatly.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. A process unit with a cleaner, comprising:
a photosensitive drum which is rotatable and has an outer circumferential surface on which magnetic toner is to be sticked; and
a cleaner which removes magnetic toner sticking on the outer circumferential surface of the photosensitive drum,
the cleaner including
a blade which scrapes the magnetic toner sticking on the outer circumferential surface of the photosensitive drum from the outer circumferential surface,
a paddle which has a rotation center and at least one arm projecting outward in a radial direction from the rotation center, rotates in a predetermined direction at a position near a toner scraping position by the blade on the outer circumferential surface of the photosensitive drum, and moves cyclically the scraped magnetic toner scraped from the outer circumferential surface of the photosensitive drum by the blade, from the toner scraping position,
a magnet which is provided on the arm in a side opposite to a direction in which the paddle rotates, and attracts the scraped magnetic toner on the arm of the paddle in another side of the arm in the direction in which the paddle rotates, by a magnetic force,
a scraper which is provided in a side of the paddle opposite to the outer circumferential surface of the photosensitive drum, contacts the arm of the paddle in the side located in the direction in which the paddle rotates during rotation of the paddle, and scrapes off the magnetic toner attracted on the arm of the paddle in the side located in the direction in which the paddle rotates, by the magnetic force, and
a scraped-magnetic toner receiver which receives the scraped magnetic toner scraped off from the arm of the paddle.

2. A process unit with a cleaner, according to claim 1, wherein at least the arm of the paddle is formed of electric conductive material.

3. A process unit with a cleaner, according to claim 1, wherein the paddle has a plurality of arms.

4. A process unit with a cleaner, according to claim 1, wherein the scraper further functions as the scraped-magnetic toner receiver.

5. A process unit with a cleaner, according to claim 4, wherein
the cleaner includes a housing containing the blade, the paddle, the scraper, and the scraped-magnetic toner receiver,
the scraper has a tip end portion which contacts the arm of the paddle, a base end portion fixed to the housing, and an intermediate portion between the tip end portion and the base end portion, and
in the housing, the tip end portion of the scraper is located above at least the intermediate portion.

6. An image forming apparatus comprising:
a conveyor which conveys a recording paper upward;
a photosensitive drum which rotates in a predetermined direction;
a charger which charges an outer circumferential surface of the photosensitive drum;
an exposing device which forms a desired electrostatic latent image on the charged outer circumferential surface of the photosensitive drum;
a developing device which develops the electrostatic latent image by magnetic toner and forms a toner image;
a transfer device which transfers the toner image formed on the outer circumferential surface of the photosensitive drum, to the recording paper being conveyed; and
a cleaner which removes the magnetic toner sticking on the outer circumferential surface of the photosensitive drum, after transferring the toner image from the outer circumferential surface of the photosensitive drum to the recording paper being conveyed by the conveyor,
the cleaner being provided adjacent to an upper part of the outer circumferential surface of the photosensitive drum, and
the cleaner including
a blade which scrapes the magnetic toner sticking on the outer circumferential surface of the photosensitive drum from the outer circumferential surface,
a paddle which has a rotation center and at least one arm projecting outward in a radial direction from the rotation center, rotates in a predetermined direction at a position near a toner scraping position by the blade on the outer circumferential surface of the photosensitive drum, and moves cyclically the scraped magnetic toner scraped from the outer circumferential surface of the photosensitive drum by the blade, from the toner scraping position,
a magnet which is provided on the arm in a side opposite to a direction in which the paddle rotates, and attracts the scraped magnetic toner on the arm of the paddle in another side of the arm located in the direction in which the paddle rotates, by a magnetic force,
a scraper which is provided in a side of the paddle opposite to the outer circumferential surface of the photosensitive drum, contacts the arm of the paddle in the side located in the direction in which the paddle rotates during rotation of the paddle, and scrapes off the magnetic toner attracted on the arm of the paddle in the side located in the direction in which the paddle rotates, by the magnetic force, and
a scraped-magnetic receiver which receives the scraped magnetic toner scraped off from the arm of the paddle.

7. An image forming apparatus according to claim 6, wherein at least the arm of the paddle is formed of conductive material.

8. An image forming apparatus according to claim 6, wherein the paddle has a plurality of arms.

9. An image forming apparatus according to claim 6, wherein the scraper further functions as the scraped-toner receiver.

10. An image forming apparatus according to claim 9, wherein
the cleaner includes a housing containing the blade, the paddle, the scraper, and the scraped-toner receiver, and
the scraper has a tip end portion which contacts the arm of the paddle, a base end portion fixed to the housing, and an intermediate portion between the tip end portion and the base end portion, and
in the housing, the tip end portion of the scraper is located above at least the intermediate portion.
